(19) United States
(12) Patent Application Publication
(10) Pub. No.: US 2026/0371134 A1
(43) Pub. Date: Nov. 19, 2026

(54) SENSING MEASUREMENT METHOD AND APPARATUS

(71) Applicant: BEIJING XIAOMI MOBILE SOFTWARE CO., LTD., Beijing (CN)

(72) Inventors: Qingyu LAI, Beijing (CN); Yumin WU, Beijing (CN); Huilong ZHANG, Beijing (CN)

(73) Assignee: BEIJING XIAOMI MOBILE SOFTWARE CO., LTD., Beijing (CN)

(21) Appl. No.: 19/475,644

(22) PCT Filed: Apr. 20, 2023
(86) PCT No.: PCT/CN2023/089615

§ 371 Date: Oct. 15, 2025

(51) Int. Cl. H04W 24/10; H04W 72/23

(52) U.S. Cl. CPC H04W 24/10; H04W 72/23

(57) ABSTRACT

A sensing measurement method, which is executed by a terminal device, comprises: receiving indication information sent by a network device, wherein the indication information is used for indicating the terminal device to report a sensing measurement result; and sending the sensing measurement result to the network device.

### CROSS-REFERENCE TO RELATED APPLICATIONS

This application is a U.S. National Phase of International Application No. PCT/CN2023/089615, filed with the State Intellectual Property Office of P. R. China on Apr. 20, 2023, the entire contents of which are incorporated herein by reference.

### TECHNICAL FIELD

The disclosure relates to the field of communication technologies, in particular to a sensing measurement method and a communication apparatus.

### BACKGROUND

An integrated sensing and communication (ISAC) system integrates a traditional radar system on the basis of an existing communication system. A sensing signal receiver realizes the sensing of information such as a distance, a speed, and an angle of a sensing object in a surrounding environment based on the received sensing signal.

### SUMMARY

According to a first aspect of embodiments of the disclosure, a sensing measurement method is provided. The method is performed by a terminal device, and includes: receiving indication information sent by a network device, in which the indication information is used for indicating the terminal device to report a sensing measurement result; and
sending the sensing measurement result to the network device.

According to a second aspect of embodiments of the disclosure, another sensing measurement method is provided. The method is performed by a network device, and includes: sending indication information to a terminal device, in which the indication information is used for indicating the terminal device to report a sensing measurement result; and
receiving the sensing measurement result sent by the terminal device.

According to a third aspect of embodiments of the disclosure, a communication device is provided. The communication device includes: a processor and a memory. The memory stores a computer program, and when the processor executes the computer program stored in the memory, the communication device is caused to implement the method described in the first aspect above.

According to a fourth aspect of embodiments of the disclosure, a communication device is provided. The communication device includes: a processor and a memory. The memory stores a computer program, and when the processor executes the computer program stored in the memory, the communication device is caused to implement the method described in the second aspect above.

According to a fifth aspect of embodiments of the disclosure, a communication device is provided. The communication device includes: a processor and an interface circuit. The interface circuit is configured to receive code instructions and transmit the code instructions to the processor, and the processor is configured to run the code instructions to cause the device to implement the method described in the first aspect.

According to a sixth aspect of embodiments of the disclosure, a communication device is provided. The communication device includes: a processor and an interface circuit. The interface circuit is configured to receive code instructions and transmit the code instructions to the processor, and the processor is configured to run the code instructions to cause the device to implement the method described in the second aspect.

According to a seventh aspect of embodiments of the disclosure, a non-transitory computer-readable storage medium is provided. The computer-readable storage medium is configured to store instructions used by the above receiver. When the instructions are executed, the receiver is caused to implement the method of the first aspect.

According to an eighth aspect of embodiments of the disclosure, a non-transitory computer-readable storage medium is provided. The readable storage medium is configured to store instructions used by the above transmitter. When the instructions are executed, the transmitter is caused to implement the method of the second aspect.

### BRIEF DESCRIPTION OF THE DRAWINGS

In order to clearly illustrate technical solutions of the embodiments of the disclosure or background technologies, descriptions of drawings used in the embodiments of the disclosure or the background technologies are given below.

FIG. 1 is a schematic structural diagram of a communication system provided by the disclosure.

FIG. 2 is a flowchart of a sensing measurement method provided by an embodiment of the disclosure.

FIG. 3 is a flowchart of a sensing measurement method provided by an embodiment of the disclosure.

FIG. 4 is a flowchart of a sensing measurement method provided by an embodiment of the disclosure.

FIG. 5 is a flowchart of a sensing measurement method provided by an embodiment of the disclosure.

FIG. 6 is a flowchart of a sensing measurement method provided by an embodiment of the disclosure.

FIG. 7 is a structural diagram of a communication apparatus provided by an embodiment of the disclosure.

FIG. 8 is a structural diagram of a communication device provided by an embodiment of the disclosure.

FIG. 9 is a schematic structural diagram of a chip provided by an embodiment of the disclosure.

### DETAILED DESCRIPTION

To facilitate understanding of the technical solutions of the disclosure, a term involved in the embodiments of the disclosure is briefly introduced below.

### 1. Radar Cross Section (RCS)

RCS is a physical quantity that represents an intensity of an echo reflected by a sensing target under the irradiation of radar waves. It is an imaginary area of the target, which is represented by a projected area of an isotropic equivalent reflector.

In order to better understand a sensing measurement method and a communication apparatus disclosed in the embodiments of the disclosure, a communication system to which the embodiments of the disclosure are applicable is described first.

FIG. 1 is a schematic structural diagram of a communication system provided by an embodiment of the disclosure. The communication system includes, but is not limited to, one network device and one terminal device. The numbers and the forms of devices illustrated in FIG. 1 are only for examples and do not constitute a limitation on the embodiments of the disclosure, and two or more network devices and two or more terminal devices may be included in practical applications. By way of example, the communication system in FIG. 1 only includes one network device 101 and one terminal device 102.

It is noted that the technical solutions of the embodiments of the disclosure may be applied to various communication systems, such as, a long term evolution (LTE) system, a 5th generation (5G) mobile communication system, a 5G new radio (NR) system, or other future new mobile communication systems.

The network device 101 in an embodiment of the disclosure is an entity on a network side, which is used for transmitting or receiving signals and communicating with a terminal device. The network device 101 may be a base transceiver station (BTS) in a global system for mobile communications (GSM) system or a code division multiple access (CDMA) system, a NodeB (NB) in a wideband code division multiple access (WCDMA) system, an evolved NodeB (eNodeB (eNB)) in an LTE system, a wireless controller in a cloud radio access network (CRAN) scenario, a radio network controller (RNC), a base station controller (BSC), a home evolved NodeB or home NodeB (HNB), or a baseband unit (BBU). The network device may also be a relay station, an access point (AP), a vehicle-mounted device, a wearable device, a network device in a 5G network or a future evolved public land mobile network (PLMN) network, an AP in a wireless local area network (WLAN), a wireless relay node, a wireless backhaul node, a transmission point (TP) or a transmission and reception point (TRP), a gNB/TRP/TP in a NR system, one antenna panel or a group of antenna panels (including a plurality of antenna panels) of a base station in a 5G system, a network node constituting a gNB or a TP, such as a BBU, or a distributed unit (DU). The specific technology and specific device form adopted by the network device are not limited in the embodiment of the disclosure. The network device provided by the embodiment of the disclosure may be composed of a central unit (CU) and distributed units (DUs). The CU may also be called a control unit. The use of CU-DU structure allows to divide a protocol layer of the network device, such that some functions of the protocol layer are placed in the CU for centralized control, and some or all of the remaining functions of the protocol layer are distributed in the DUs, and the DUs are centrally controlled by the CU.

The terminal device 102 in an embodiment of the disclosure may be a device that provides voice/data connectivity to a user, such as a handheld device or a vehicle-mounted device with a wireless connection function. The terminal device may be, for example, a mobile phone, a tablet computer, a laptop computer, a palmtop, a mobile internet device (MID), a wearable device, a virtual reality (VR) device, an augmented reality (AR) device, a wireless terminal device in industrial control, a wireless terminal device in self driving, a wireless terminal device in remote medical surgery, a wireless terminal device in smart grid, a wireless terminal device in transportation safety, a wireless terminal device in smart city, a wireless terminal device in smart home, a cellular phone, a cordless phone, a session initiation protocol (SIP) phone, a wireless local loop (WLL) station, a personal digital assistant (PDA), a handheld device with wireless communication capabilities, a computing device or other processing devices connected to a wireless modem, a vehicle-mounted device, a wearable device, a terminal device in a 5G network or a future evolved PLMN and/or any other suitable devices for communicating on a wireless communication system, which is not limited by the embodiment of the disclosure.

The wearable device may also be called a wearable smart device, which is a general term for wearable devices for daily use obtained through intelligent design and development using wearable technologies, such as glasses, watches, clothing and shoes. The wearable device is a portable device that is worn directly on the body or used by integrating into clothing or accessories of users. The wearable device is not just a hardware device, but also a device used to realize powerful functions through software support, data interaction and cloud interaction. In a broad sense, wearable smart device refers to devices that are fully functional, large in size, and can implement all or part of functions without relying on smartphones, e.g., smart watch and smart glasses, as well as devices that only focus on a certain type of application function and need to be used in combination with other devices such as smartphones, e.g., various smart bracelets and smart jewelries for vital sign monitoring.

In an embodiment of the disclosure, the terminal device 102 may also be a terminal device in an Internet of Things (IoT) system. The IoT is an important part of future development of information technologies. Its main technical feature is to connect objects to the network through communication technologies, to generate an intelligent network of human-machine interconnection and object-to-object interconnection.

In the embodiment of the disclosure, the terminal device 102 may also include sensors such as smart printers, train detectors, and gas stations. Its main functions include collecting data (for some terminal devices), receiving control information and downlink data from the network side device, and sending uplink data to the network side device via electromagnetic waves.

It should be noted that the technical solutions of the embodiments of the disclosure may be applied to various communication systems, such as an LTE system, a 5G mobile communication system, a 5G NR system or other future new mobile communication systems.

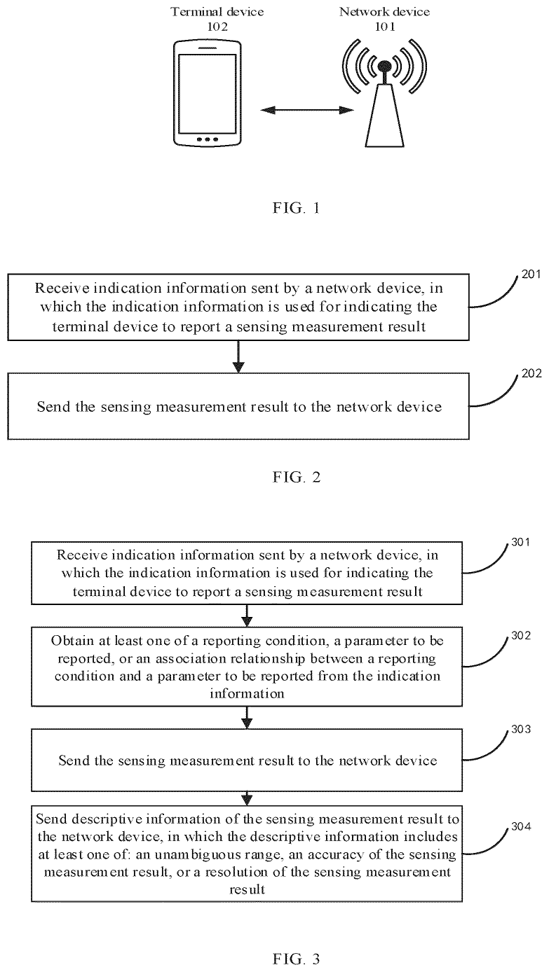

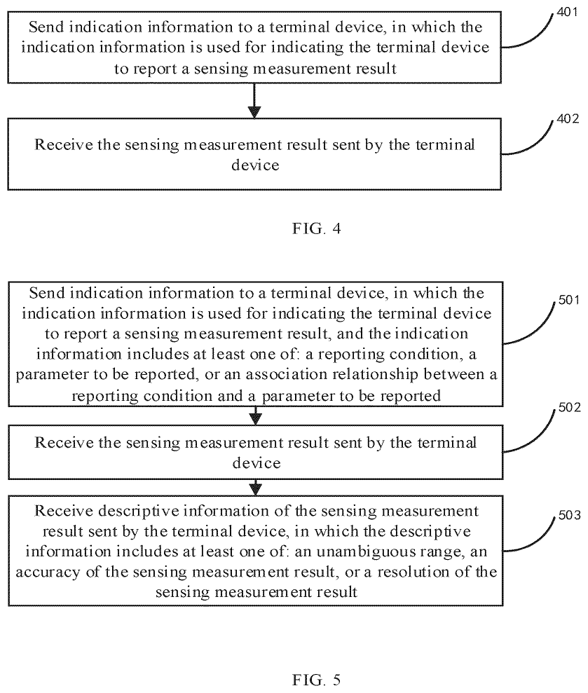

The terminal device 102 provided in an embodiment of the disclosure may implement the method in the embodiments of FIGS. 2-3, and the network device 101 may implement the method in the embodiments of FIGS. 4-5.

It is understandable that the communication system is described first in the embodiment of the disclosure, so that the technical solution provided by the embodiments of the disclosure can be clearly illustrated, and the description of the communication system does not constitute a limitation on the technical solution provided by the embodiments of the disclosure. It is understandable by those skilled in the art that as system architectures evolve and new business scenarios emerge, the technical solution provided by the embodiments of the disclosure are also applicable to similar technical problems.

In order to facilitate understanding of the embodiments of the disclosure, the following points need to be made clear.

Firstly, “first”, “second” and other numerical numbers in the disclosure are only used for the convenience of description and are not used to limit the scope of the embodiments of the disclosure. For example, these numbers may be used for distinguishing different information or distinguishing different terminal devices.

Secondly, the term “protocol” involved in the embodiments of the disclosure may refer to a standard protocol in the communication field, for example, an LTE protocol, a NR protocol or other related protocols used in future communication systems, which is not limited in the disclosure.

Thirdly, the embodiments of the disclosure list a plurality of implementations to clearly illustrate the technical solutions of the embodiments of the disclosure. Certainly, those skilled in the art understand that some of the embodiments of the disclosure can be executed individually, or can be executed together with methods of other embodiments in the embodiments of the disclosure, or can be executed in combination with some methods in related arts, which is not limited in the embodiments of the disclosure.

An embodiment of the disclosure provides a sensing measurement method. In the method, a network device sends an indication to a terminal device to report a sensing measurement result, thereafter, the terminal device sends the sensing measurement result to the network device. Therefore, a UE can report the sensing measurement result to the network.

A sensing measurement method and a communication apparatus provided by the disclosure will be introduced in detail with reference to the accompanying drawings.

FIG. 2 is a flowchart of a sensing measurement method provided by an embodiment of the disclosure. As illustrated in FIG. 2, the method is applied to a terminal device, and includes, but is not limited to, the following steps.

At step 201, indication information sent by a network device is received, in which the indication information is used for indicating the terminal device to report a sensing measurement result.

In a disclosure, the terminal device may receive the indication information sent by the network device via any message, such as a radio resource control (RRC) message and downlink control information (DCI), etc., which is not limited in the disclosure.

In some possible implementations, the indication information includes at least one of: a reporting condition, a parameter to be reported, or an association relationship between a reporting condition and a parameter to be reported.

The reporting condition is used for indicating a condition for the terminal device to report the sensing measurement result. The terminal device will report the sensing measurement result after determining that the reporting condition is met. The parameter to be reported refers to a parameter that needs to be report to the network device by the terminal device, such as measured coordinates of a sensing object, and a moving speed of a sensing object, which is not limited by the disclosure.

In some possible implementations, the network device may require the terminal device to report different parameters when different reporting conditions are met, then the indication information may also include the association relationship between a reporting condition and a parameter to be reported.

At step 202, the sensing measurement result is sent to the network device.

In a disclosure, in a case that an indication information from a network device is received, the terminal device may send a sensing measurement result to the network device after a sensing measurement is completed.

In some possible implementations, in a case the indication information includes a reporting condition, the terminal device may send a sensing measurement result to the network device after the reporting condition is met. For example, if the reporting condition is a distance threshold, the terminal device may send a measurement result of a sensing object, such as distance information of the sensing object, to the network device when a measured distance of the sensing object meets the distance threshold during the sensing measurement.

In some possible implementations, in a case the indication information includes a parameter to be reported, the terminal device may measure or calculate the parameter to be reported indicated in the indication information during sensing measurement. After determining the parameter value, the terminal device sends the determined parameter value to the network device.

In some possible implementations, in a case the indication information includes a reporting condition, a parameter to be reported and the association relationship between the reporting condition and the parameter to be reported, if any reporting condition is met, the terminal device may send the parameter to be reported associated with the reporting condition to the network device.

It should be noted that in the embodiments of the disclosure, information such as coordinates of a sensing object, a moving speed of the sensing object, or a distance of the sensing object may refer to coordinates of the sensing object relative to the terminal device, a moving speed of the sensing object relative to the terminal device, or a distance of the sensing object relative to the terminal device, or may refer to coordinates of the sensing object relative to the network device, a moving speed of the sensing object relative to the network device, or a distance of the sensing object relative to the network device.

The terminal device receives indication information sent by a network device, performs a sensing measurement, and then sends a sensing measurement result to the network device. This enables the terminal device to report the sensing measurement result to the network as required.

FIG. 3 is a flowchart of a sensing measurement method provided by an embodiment of the disclosure. As illustrated in FIG. 3, the method is applied to a terminal device, and includes, but is not limited to, the following steps.

At step 301, indication information sent by a network device is received, in which the indication information is used for indicating the terminal device to report a sensing measurement result.

The specific implementation of step 301 may refer to the detailed descriptions of other embodiments, which will not be repeated here.

At step 302, at least one of a reporting condition, a parameter to be reported, or an association relationship between a reporting condition and a parameter to be reported is obtained from the indication information.

In some possible implementations, the reporting condition includes one or more of a distance threshold, a trigger event and a time threshold, which is not limited by the disclosure.

The distance threshold is a distance threshold set to trigger the reporting of the measurement result in a case the network device configures the sensing measurement for the terminal device. For example, if the distance threshold is 10 m, the terminal device needs to report a sensing measurement result to the network device when the sensing measurement result is equal to or less than 10 m.

The trigger event is an event set to trigger the terminal device to report the measurement result in a case the network device configures the sensing measurement for the terminal device. For example, if the trigger event is that a moving speed of the terminal device is greater than a speed threshold, the terminal device needs to report a sensing measurement result to the network device when it determines that its own moving speed is greater than the speed threshold. Or, if the trigger event is that an intensity of a signal received by the terminal device is greater than an intensity threshold, the terminal device reports the sensing measurement result to the network device when it determines that the intensity of the signal it receives is greater than the intensity threshold during the sensing measurement. The specific implementations of the trigger event are not limited by the disclosure, and the trigger event may be any event that can trigger the terminal device to report a sensing measurement result.

The time threshold is a time threshold set for triggering the reporting of the measurement result in a case the network device configures the sensing measurement for the terminal device. For example, if the time threshold is one minute, the terminal device needs to report a sensing measurement result to the network device once every minute, which is not limited by the disclosure.

In some possible implementations, a parameter to be reported includes one or more of: first coordinate information of a sensing object, an RCS of the sensing object, angle information of the sensing object, distance information of the sensing object, a motion state of the sensing object, an angle of arrival of a sensing signal, a time of arrival of the sensing signal, a power of the sensing signal, second coordinate information of the terminal device, and a motion state of the terminal device, which is not limited by the disclosure.

The first coordinate information may be initial coordinates of a sensing object or coordinates of the sensing object at different moments. That is, for a moving sensing object, the network device may indicate the terminal device to report an initial coordinates of the sensing object, or may indicate the terminal device to report coordinates of the sensing object at different moments, such as a motion trajectory of the sensing object, which is not limited by the disclosure.

The angle information of the sensing object may be an angle of the sensing object relative to the terminal device or an angle of the sensing object relative to the network device, which is not limited by the disclosure. In an embodiment of the disclosure, the angle information may also include an angle of a moving direction of the sensing object relative to the terminal device, or an angle of a moving direction of the sensing object relative to the network device, which is not limited by the disclosure.

The angle of arrival of the sensing signal is a measurement of a propagation direction of the sensing signal reaching the terminal device, that is, an angle between the sensing signal and a given direction (a horizontal plane or a normal line on the horizontal plane).

The power of the sensing signal is a power value of the sensing signal received by the terminal device.

The second coordinate information is coordinates of the terminal device at the time the sensing signal is detected.

It should be noted that the above parameters of the sensing object, such as the first coordinate information, the angle information, the distance information and the motion state of the sensing object, may be parameters relative to the terminal device or parameters relative to the network device. For example, the distance information may be the distance between the sensing object and the terminal device or the distance between the sensing object and the network device, which is not limited by the disclosure.

At step 303, the sensing measurement result is sent to the network device.

The specific implementation of step 303 may refer to the detailed descriptions of other embodiments of the disclosure, which will not be repeated here.

In some possible implementations, in a case the indication information includes a reporting condition, the terminal device may send the sensing measurement result to the network device after determining that the reporting condition is met.

For example, if the indication information includes a trigger event (e.g., the sensing object is in a motion state) and a distance threshold (between the sensing object and the terminal device), when the terminal device determines that the distance between the sensing object and the terminal device meets the distance threshold based on the sensing measurement result, and the sensing object is in the motion state (i.e., the trigger event is detected), it may send the measurement result of the sensing object to the network device.

Or, if the indication information includes a time threshold and a distance threshold, the terminal device may send the measurement result of the sensing object that meets the distance threshold to the network device after the time threshold is met.

At step 304, descriptive information of the sensing measurement result is sent to the network device, in which the descriptive information includes at least one of: an unambiguous range, an accuracy of the sensing measurement result, or a resolution of the sensing measurement result.

The unambiguous range refers to a distance range or a speed range for the terminal device to accurately measure the sensing object while operating in a multiple-objects environment. The range is determined by the nature and material of the terminal device, which is not limited by the disclosure.

The accuracy refers to a similarity between a measurement value and an actual value when the terminal device performs the sensing measurement on the sensing object.

The resolution is a capability of the terminal device to distinguish two or more objects in a multiple-objects environment, which is generally distinguished from four aspects: a distance, an azimuth, a speed and an elevation angle. The resolution of distance depends on a signal bandwidth, and the resolution of the azimuth and the elevation angle depends on a beam width. The signal bandwidth is a range of the signal, and the beam width is an angle between two half-power points of a main lobe. Generally. Antenna radiation patterns typically have two or more lobes, with the largest lobe is called a main lobe and the remaining lobes are called side lobes.

It should be noted that the specific parameter information included in the descriptive information may be configured by the network device or determined by the terminal device based on a protocol, which is not limited by the disclosure.

In some possible implementations, the terminal device may send the sensing measurement result and the descriptive information of the sensing measurement result to the network device through a message, which is not limited by the disclosure.

In a disclosure, the terminal device sends descriptive information of the sensing measurement result to the network device, so that the network device may more accurately and comprehensively understand the measurement result sent by the terminal device based on the descriptive information of the measurement result.

In conclusion, after receiving the indication sent by the network device, which is used to indicate the terminal device to report the sensing measurement result, the terminal device may obtain one or more of the reporting condition, the parameter to be reported, and the association relationship between the reporting condition and the parameter to be reported from the indication information, and then may send the sensing measurement result and the description information of the sensing measurement result to the network device according to the indication, thus realizing the reporting of the sensing measurement result and ensuring consistent understanding of the sensing measurement result between the network device and the terminal device.

FIG. 4 is a flowchart of a sensing measurement method provided by an embodiment of the disclosure. As illustrated in FIG. 4, the method is applied to a network device, and includes, but is not limited to, the following steps.

At step 401, indication information is sent to a terminal device, in which the indication information is used for indicating the terminal device to report a sensing measurement result.

In a disclosure, the network device may send the indication information to the terminal device via any message, such as an RRC message and DCI, etc., which is not limited in the disclosure.

In some possible implementations, the indication information includes at least one of: a reporting condition, a parameter to be reported, or an association relationship between a reporting condition and a parameter to be reported.

The reporting condition is used for indicating a condition for the terminal device to report the sensing measurement result. The network device receives the sensing measurement result sent by the terminal device that meet the reporting condition. The parameter to be reported refers to a parameter in the sensing measurement result sent by the terminal device to the network device, such as measured coordinates of a sensing object, and a moving speed of a sensing object, which is not limited by the disclosure.

In some possible implementations, the network device may require the terminal device to report different parameters when different reporting conditions are met, then the indication information may also include the association relationship between the reporting condition and the report parameter.

At step 402, the sensing measurement result sent by the terminal device is received.

In a disclosure, after the network device sends the indication information to the terminal device, the terminal device performs sensing measurement and then sends a sensing measurement result to the network device, and then the network device receives the sensing measurement result sent by the terminal device.

In some possible implementations, in a case the indication information includes the reporting condition, the network device may receive the sensing measurement result sent by the terminal device if the sensing measurement result of the terminal device meets the reporting condition. For example, if the reporting condition is a distance threshold, the terminal device may perform the sensing measurement, and if the measured distance of the sensing object meets the distance threshold, the network device may receive the measurement result of the sensing object sent by the terminal device, such as distance information of the sensing object.

In some possible implementations, in a case the indication information includes the parameter to be reported, the network device sends the sensing measurement result including the parameter to be reported to the terminal device, the terminal device performs a sensing measurement, measures or calculates the parameter to be reported indicated in the indication information, and then determines a parameter value and sends the parameter value to the network device. Correspondingly, the network device receives the determined parameter value sent by the terminal device.

In some possible implementations, in a case the indication information includes the reporting condition, the parameter to be reported and the association relationship between the reporting condition and the parameter to be reported, if the sensing measurement result of the terminal device meets any reporting condition, the network device may receive a reported parameter associated with the reporting condition in the sensing measurement result sent by the terminal device.

It should be noted that in the embodiments of the disclosure, information such as coordinates of a sensing object, a moving speed of the sensing object, or a distance of the sensing object may refer to coordinates of the sensing object relative to the terminal device, a moving speed of the sensing object relative to the terminal device, or a distance of the sensing object relative to the terminal device, or may refer to coordinates of the sensing object relative to the network device, a moving speed of the sensing object relative to the network device, or a distance of the sensing object relative to the network device.

In conclusion, the network device sends the indication to the terminal device, and then the terminal device performs a sensing measurement and sends a sensing measurement result to the network device. Then, the network device receives the sensing measurement result sent by the terminal device. Therefore, the network device may send the sensing measurement indication to the terminal device as needed and receive the sensing measurement result of the terminal device.

FIG. 5 is a flowchart of a sensing measurement method provided by an embodiment of the disclosure. As illustrated in FIG. 5, the method is applied to a network device, and includes, but is not limited to, the following steps.

At step 501, indication information is sent to a terminal device, in which the indication information is used for indicating the terminal device to report a sensing measurement result. The indication information includes at least one of: a reporting condition, a parameter to be reported, or an association relationship between a reporting condition and a parameter to be reported.

In some possible implementations, the reporting condition includes one or more of: a distance threshold, a trigger event and a time threshold, which is not limited by the disclosure.

The distance threshold is a distance threshold set to trigger the reporting of the measurement result when the network device configures the sensing measurement for the terminal device. For example, if the distance threshold is 10 m, the terminal device needs to report the sensing measurement result to the network device when the sensing measurement result is equal to or less than 10 m.

The trigger event is an event set to trigger the terminal device to report the measurement result when the network device configures the sensing measurement for the terminal device. For example, if the trigger event is that a moving speed of the terminal device is greater than a speed threshold, the terminal device needs to report the sensing measurement result to the network device when it determines that its own moving speed is greater than the speed threshold. Or, if the trigger event is that an intensity of a signal received by the terminal device is greater than an intensity threshold, the terminal device reports the sensing measurement result to the network device when it determines that the intensity of the signal it receives is greater than the intensity threshold during the sensing measurement. The specific implementations of the trigger event are not limited by the disclosure, and the trigger event can be any event that can trigger the terminal device to report the sensing measurement result.

The time threshold is a time threshold set for triggering the reporting of the measurement result when the network device configures the sensing measurement for the terminal device. For example, if the time threshold is one minute, the terminal device needs to report the sensing measurement result to the network device once every minute, which is not limited by the disclosure.

In some possible implementations, the parameter to be reported includes one or more of: first coordinate information of a sensing object, an RCS of the sensing object, angle information of the sensing object, distance information of the sensing object, a motion state of the sensing object, an angle of arrival of a sensing signal, a time of arrival of the sensing signal, a power of the sensing signal, second coordinate information of the terminal device, and a motion state of the terminal device, which is not limited by the disclosure.

The first coordinate information may be initial coordinates of a sensing object or coordinates of the sensing object at different moments. That is, for a moving sensing object, the network device may indicate the terminal device to report the initial coordinates of the sensing object, or may indicate the terminal device to report the coordinates of the sensing object at different moments, such as a motion trajectory of the sensing object, which is not limited by the disclosure.

The angle information of the sensing object may be an angle of the sensing object relative to the terminal device or an angle of the sensing object relative to the network device, which is not limited by the disclosure. In an embodiment of the disclosure, the angle information may also include an angle of a moving direction of the sensing object relative to the terminal device, or an angle of a moving direction of the sensing object relative to the network device, which is not limited by the disclosure.

The angle of arrival of the sensing signal is a measurement of a propagation direction of the sensing signal reaching the terminal device, such as an angle between the sensing signal and a given direction (a horizontal plane or a normal line on the horizontal plane).

The power of the sensing signal is a power value of the sensing signal received by the terminal device.

The second coordinate information is coordinates of the terminal device when the sensing signal is detected.

It should be noted that the above parameters of the sensing object, such as the first coordinate information, the angle information, the distance information and the motion state of the sensing object, may be parameters relative to the terminal device or parameters relative to the network device. For example, the distance information may be the distance between the sensing object and the terminal device or the distance between the sensing object and the network device, which is not limited by the disclosure.

At step 502, the sensing measurement result sent by the terminal device is received.

The specific implementation of step 502 may refer to the detailed descriptions of other embodiments of the disclosure, which will not be repeated here.

In some possible implementations, in a case the indication information includes the reporting condition, the sensing measurement result received by the network device is sent by the terminal device after determining that the reporting condition is met.

For example, if the indication information includes a trigger event (e.g., the sensing object is in a motion state) and a distance threshold (between the sensing object and the terminal device), when the terminal device determines that the distance between the sensing object and the terminal device meets the distance threshold based on the sensing measurement result, and the sensing object is in the motion state (i.e., the trigger event is detected), the network device may receive the measurement result of the sensing object sent by the terminal device.

Or, if the indication information includes a time threshold and a distance threshold, if the sensing measurement result of the terminal device meets the time threshold, the network device may receive the measurement result of the sensing object that meets the distance threshold sent by the terminal device.

At step 503, descriptive information of the sensing measurement result sent by the terminal device is received, in which the descriptive information includes at least one of: an unambiguous range, an accuracy of the sensing measurement result, or a resolution of the sensing measurement result.

The unambiguous range refers to a distance range or a speed range for the terminal device to accurately measure the sensing object while operating in a multiple-objects environment. The range is determined by the nature and material of the terminal device, which is not limited by the disclosure.

The accuracy refers to a similarity between a measurement value and an actual value when the terminal device performs the sensing measurement on the sensing object.

The resolution is a capability of the terminal device to distinguish two or more objects in a multiple-objects environment, which is generally distinguished from four aspects: a distance, an azimuth, a speed and an elevation angle. The resolution of distance depends on a signal bandwidth, and the resolution of the azimuth and the elevation angle depends on a beam width. The signal bandwidth is a range of the signal, and the beam width is an angle between two half-power points of a main lobe. Generally, Antenna radiation patterns typically have two or more lobes, with the largest lobe is called a main lobe and the remaining lobes are called side lobes.

It should be noted that the specific parameter information included in the descriptive information may be configured by the network device or determined by the terminal device based on a protocol, which is not limited by the disclosure.

In some possible implementations, the network device may receive the sensing measurement result and the descriptive information of the sensing measurement result sent by the terminal device through a message, which is not limited by the disclosure.

In a disclosure, after receiving the descriptive information of the sensing measurement result sent by the terminal device, the network device may more accurately and comprehensively understand the measurement result sent by the terminal device based on the descriptive information of the measurement result.

In conclusion, the network device first sends the indication information to the terminal device to indicate the terminal device to report the sensing measurement result when one or more of the reporting condition, the parameter to be reported, and the association relationship between the reporting condition and the report parameter to be reported can be met, and then it receives the sensing measurement result and the description information of the sensing measurement result sent by the terminal device, thus realizing the reporting of the sensing measurement result and ensuring consistent understanding of the sensing measurement result between the network device and the terminal device.

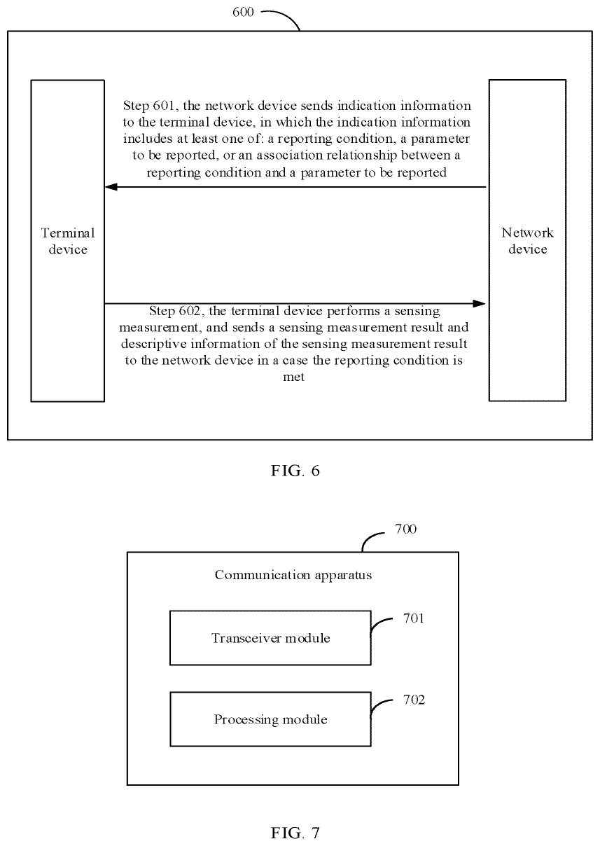

FIG. 6 is a flowchart of a sensing measurement method provided by an embodiment of the disclosure. As illustrated in FIG. 6, the method is applied to an interaction between a terminal device and a network device. The method includes, but is not limited to, the following steps.

At step 601, the network device sends indication information to the terminal device, in which the indication information includes at least one of: a reporting condition, a parameter to be reported, or an association relationship between a reporting condition and a parameter to be reported.

At step 602, the terminal device performs a sensing measurement, and sends a sensing measurement result and descriptive information of the sensing measurement result to the network device in a case the reporting condition is met.

In conclusion, through the simple interaction between the terminal device and the network device, the reporting of the sensing measurement result is realized, and the consistent understanding of the sensing measurement result between the network device and the terminal device can be ensured.

FIG. 7 is a schematic structural diagram of a communication device 700 provided by an embodiment of the disclosure. The communication device 700 shown in FIG. 7 includes a transceiver module 701 and a processing module 702. The transceiver module includes a sending module and/or a receiving module. The sending module is used for implementing a sending function, the receiving module is used for implementing a receiving function, and the transceiver module is used for implementing the sending function and/or the receiving function.

The communication device 700 may be a terminal device, a device in the terminal device, or a device that can be used together with the terminal device.

If the communication device 700 is on the terminal device side, the transceiver module 701 is configured to receive indication information sent by a network device, in which the indication information is used for indicating the terminal device to report a sensing measurement result; and the transceiver module 701 is further configured to send the sensing measurement result to the network device.

The transceiver module 701 is further configured to:
send descriptive information of the sensing measurement result to the network device, in which the descriptive information includes at least one of: an unambiguous range, an accuracy of the sensing measurement result, or a resolution of the sensing measurement result.

In conclusion, the terminal device receives the indication information sent by the network device, performs the sensing measurement, and then sends the sensing measurement result to the network device. Therefore, the terminal device may send the sensing measurement result to the network as required.

The communication device 700 may be a network device, a device in the network device, or a device that can be used together with the network device.

If the communication device 700 is on the network device side,
the transceiver module 701 is configured to send indication information to a terminal device, in which the indication information is used for indicating the terminal device to report a sensing measurement result; and
the transceiver module 701 is further configured to receive the sensing measurement result sent by the terminal device.

In some possible implementations, the transceiver module 701 is further configured to: receive descriptive information of the sensing measurement result sent by the terminal device, in which the descriptive information includes at least one of: an unambiguous range, an accuracy of the sensing measurement result, or a resolution of the sensing measurement result.

The communication device 700 provided in the above embodiment of the disclosure can achieve the same or similar beneficial effects as the sensing measurement method provided in some of the above embodiments, which will not be described in detail here.

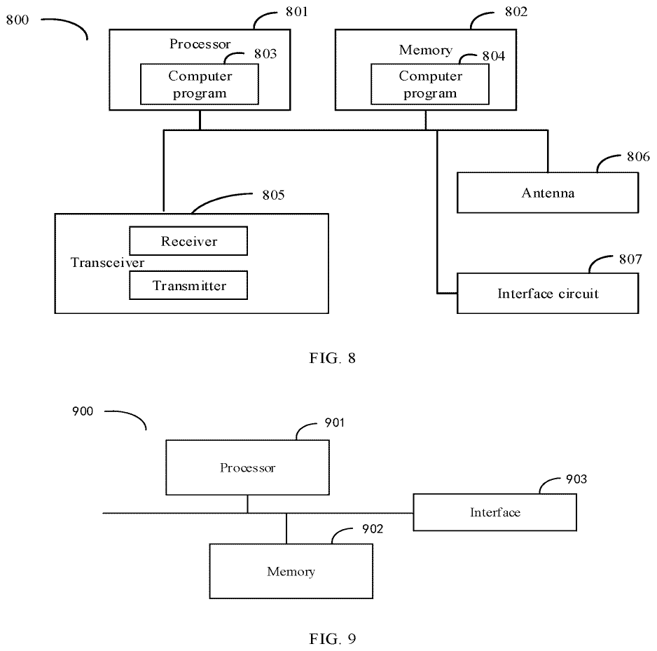

FIG. 8 is a schematic structural diagram of a communication device 800 provided by an embodiment of the disclosure. The communication device 800 may be a network device or a terminal device, or may be a chip, a chip system or a processor that supports the network device to implement the above method, or may be a chip, a chip system or a processor that supports the terminal device to implement the above method. The device 800 may be used to implement the method described in the above method embodiments with reference to the descriptions of the method embodiments.

The communication device 800 includes one or more processors 801. The processor 801 may be a general purpose processor or a dedicated processor, such as, a baseband processor and a central processor. The baseband processor is used for processing communication protocols and communication data. The central processor is used for controlling the communication device (e.g., a base station, a baseband chip, a terminal device, a terminal device chip, a DU or a CU), executing computer programs, and processing data of the computer programs.

In some possible implementations, the communication device 800 includes one or more memories 802 on which computer programs 804 are stored. The processor 801 executes the computer programs 804 to cause the communication device 800 to implement the method described in the above method embodiments. In some possible implementations, the memory 802 may also store data. The communication device 800 and the memory 802 may be provided separately or may be integrated together.

In some possible implementations, the communication device 800 also includes a transceiver 805 and an antenna 806. The transceiver 805 may be referred to as a transceiver unit, a transceiver machine or a transceiver circuit, for realizing a transceiver function. The transceiver 805 includes a receiver and a transmitter. The receiver may be referred to as a receiving machine or a receiving circuit, for realizing a receiving function. The transmitter may be referred to as a transmitter machine or a transmitting circuit, for realizing a transmitting function.

In some possible implementations, the communication device 800 may also include one or more interface circuits 807. The interface circuits 807 are used to receive code instructions and transmit the code instructions to the processor 801. The processor 801 runs the code instructions to cause the communication device 800 to implement the method described in the method embodiments.

In an implementation, the processor 801 may include a transceiver for implementing receiving and transmitting functions. The transceiver may be, for example, a transceiver circuit, an interface, or an interface circuit. The transceiver circuit, the interface, or the interface circuit for implementing the receiving and transmitting functions may be separated or may be integrated together. The transceiver circuit, the interface, or the interface circuit described above may be used for reading and writing code/data, or may be used for signal transmission or delivery.

In an implementation, the processor 801 may store a computer program 803. When the processor 80 executes the computer program 803, the communication device 800 is caused to implement the method described in the method embodiments above. The computer program 803 may be solidified in the processor 801, and in such case the processor 801 may be implemented by hardware.

In an implementation, the communication device 800 may include circuits. The circuits may implement the transmitting, receiving or communicating function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver may be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the descriptions of the above embodiments may be a terminal device, but the scope of the communication device described in the disclosure is not limited thereto, and the structure of the communication device is not limited by FIG. 8. The communication device may be a stand-alone device or may be part of a larger device. For example, the communication device may be:
(1) a stand-alone IC, a chip, a chip system or a subsystem;
(2) a collection of ICs including one or more ICs, in some possible implementations, the collection of ICs may also include a storage component for storing data and computer programs;
(3) an ASIC, such as a modem;
(4) a module that can be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

The case that the communication device may be a chip or a chip system can refer to FIG. 9. FIG. 9 is a structural diagram of a chip provided in an embodiment of the disclosure.

The chip 900 includes a processor 901 and an interface 903. There may be one or more processors 901 and several interfaces 903.

In the case where the chip is used to implement the functions of the terminal device in the embodiment of the disclosure,
the interface 903 is configured to receive code instructions and transmit the code instructions to the processor; and
the processor 901 is configured to execute the code instructions to implement the sensing measurement method as described in some embodiments above.

In the case where the chip is used to implement the functions of the transmitter in the embodiment of the disclosure,
the interface 903 is configured to receive code instructions and transmit the code instructions to the processor; and
the processor 901 is configured to execute the code instructions to implement the sensing measurement method as described in some embodiments above.

In some possible implementations, the chip 900 also includes a memory 902 for storing necessary computer programs and data.

It is understood by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of the embodiments of the disclosure.

An embodiment of the disclosure provides a communication system. The system includes a communication device as the terminal device and a communication device as the network device in the aforementioned embodiment of FIG. 7, or the system includes a communication device as the terminal device and a communication device as the network device in the aforementioned embodiment of FIG. 8.

The disclosure provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs)) or wirelessly (e.g., using infrared wave, wireless wave, or microwave). The computer-readable storage medium may be any usable medium to which the computer is capable to access or a data storage device integrated by one or more usable mediums, such as a server or a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or used to indicate the order of precedence.

The term “at least one” in the disclosure can be described as one or more, and the term “a plurality of” may refer to two, three, four or more. The term “and/or” describes association relationships of associated objects, which indicates three kinds of relationships. For example, “A and/or B” indicates that A exists alone, A and B both exist, and B exists alone, where A and B can be singular or plural. The character “/” generally indicates that the associated objects prior to and after the character “/” are in an “or” relationship. “At least one of the following items” or similar expressions refers to any combination of these items, including any combination of a single item or several items. For example, “at least one of a, b or c” represents a, b, c, a+b, a+c, b+c, or a+b+c, where a, b and c can be singular or plural, which is not limited in the disclosure. In the embodiments of the disclosure, for a type of technical features, “first”, “second” and “third”, and “A”, “B”, “C” and “D” are used to distinguish different technical features of the type, the technical features described using the “first”, “second” and “third”, and “A”, “B”, “C” and “D” do not indicate any order of precedence or magnitude.

The correspondences in the tables of the disclosure may be configured or predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables of the disclosure may not be configured, and the above tables may be adjusted appropriately, such as splitting, combining, and the like. The names of the parameters shown in the titles of the above tables may be configured to other names that can be understood by the communication device, and the values or representations of the parameters may be other values or representations that can be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in the disclosure may be understood as define, predefine, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and the design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can be referred to the corresponding processes in the preceding method embodiments, which will not be repeated herein.

The above are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the attached claims.

1. A sensing measurement method, performed by a terminal device, comprising:
receiving indication information sent by a network device, wherein the indication information is used for indicating the terminal device to report a sensing measurement result; and
sending the sensing measurement result to the network device.

2. The method according to claim 1, wherein the indication information comprises at least one of: a reporting condition, a parameter to be reported, or an association relationship between a reporting condition and a parameter to be reported.

3. The method according to claim 2, wherein the reporting condition comprises at least one of: a distance threshold, a trigger event, or a time threshold.

4. The method according to claim 2, wherein the parameter to be reported comprises at least one of:
first coordinate information of a sensing object, a radar cross section (RCS) of a sensing object, angle information of a sensing object, distance information of a sensing object, a motion state of a sensing object, an angle of arrival of a sensing signal, a time of arrival of a sensing signal, a power of a sensing signal, second coordinate information of the terminal device, or a motion state of the terminal device.

5. The method according to claim 1, further comprising:
sending descriptive information of the sensing measurement result to the network device, wherein the descriptive information comprises at least one of: an unambiguous range, an accuracy of the sensing measurement result, or a resolution of the sensing measurement result.

6. A sensing measurement method, performed by a network device, comprising:
sending indication information to a terminal device, wherein the indication information is used for indicating the terminal device to report a sensing measurement result; and
receiving the sensing measurement result sent by the terminal device.

7. The method according to claim 6, wherein the indication information comprises at least one of: a reporting condition, a parameter to be reported, or an association relationship between a reporting condition and a parameter to be reported.

8. The method according to claim 7, wherein the reporting condition comprises at least one of: a distance threshold, a trigger event, or a time threshold.

9. The method according to claim 7, wherein the parameter to be reported comprises at least one of:
first coordinate information of a sensing object, a radar cross section (RCS) of a sensing object, angle information of a sensing object, distance information of a sensing object, a motion state of a sensing object, an angle of arrival of a sensing signal, a time of arrival of a sensing signal, a power of a sensing signal, second coordinate information of the terminal device, or a motion state of the terminal device.

10. The method according to claim 6, further comprising:
receiving descriptive information of the sensing measurement result sent by the terminal device, wherein the descriptive information comprises at least one of: an unambiguous range, an accuracy of the sensing measurement result, or a resolution of the sensing measurement result.

11-12. (canceled)

13. A terminal device, comprising:
a processor; and
a memory storing instructions executable by the processor,
wherein the processor is configured to:
receive indication information sent by a network device, wherein the indication information is used for indicating the terminal device to report a sensing measurement result; and
send the sensing measurement result to the network device.

14. A communication device, comprising:
a processor and an interface circuit;
wherein the interface circuit is configured to receive code instructions and transmit the code instructions to the processor; and
the processor is configured to execute the code instructions to implement the method according to claim 1.

15. (canceled)

16. A non-transitory computer-readable storage medium for storing instructions, wherein when the instructions are executed, the method according to claim 1 is implemented.

17. A network device, comprising:
a processor; and
a memory storing instructions executable by the processor,
wherein the processor is configured to implement the method according to claim 6.

18. A communication device, comprising:
a processor; and
an interface circuit,
wherein the interface circuit is configured to receive code instructions and transmit the code instructions to the processor; and
the processor is configured to execute the code instructions to implement the method according to claim 6.

19. A non-transitory computer-readable storage medium for storing instructions, wherein when the instructions are executed, the method according to claim 6 is implemented.

20. The terminal device according to claim 13, wherein the indication information comprises at least one of: a reporting condition, a parameter to be reported, or an association relationship between a reporting condition and a parameter to be reported.

21. The terminal device according to claim 20, wherein the reporting condition comprises at least one of: a distance threshold, a trigger event, or a time threshold.

22. The terminal device according to claim 20, wherein the parameter to be reported comprises at least one of:
first coordinate information of a sensing object, a radar cross section (RCS) of a sensing object, angle information of a sensing object, distance information of a sensing object, a motion state of a sensing object, an angle of arrival of a sensing signal, a time of arrival of a sensing signal, a power of a sensing signal, second coordinate information of the terminal device, or a motion state of the terminal device.

23. The terminal device according to claim 13, wherein the processor is further configured to:
send descriptive information of the sensing measurement result to the network device, wherein the descriptive information comprises at least one of: an unambiguous range, an accuracy of the sensing measurement result, or a resolution of the sensing measurement result.
